(19) United States
(12) Patent Application Publication
(10) Pub. No.: US 2010/0110311 A1
(43) Pub. Date: May 6, 2010

(54) METHOD AND SYSTEM FOR ADJUSTING A PRESENTATION OF IMAGE DATA

(75) Inventors: Sharon Sade, Kfar-Yona (IL); Noam Sorek, Zikhron-Yaakov (IL); Liran Shimshi, Ramat-Gan (IL); Ido Dotan, Tel-Aviv (IL)

Correspondence Address: MARTIN D. MOYNIHAN d/b/a PRTSI, INC., P.O. BOX 16446, ARLINGTON, VA, 22215, US

(73) Assignee: Samsung Electronics Co., Ltd., Gyeonggi-do (KR)

(21) Appl. No.: 12/261,164

(22) Filed: Oct. 30, 2008

(51) Int. Cl. H04N 5/74

(52) U.S. Cl. 348/750; 348/E05.137

(57) ABSTRACT

A handheld device configured for displaying a modulated image. The handheld device comprises an image generation unit configured for projecting at least one light. The at least one light beam corresponding to image data and allows a presentation of the image data to a user. The handheld device further comprises a user interface configured for receiving at least one instruction for adjusting a display of said image data from the user and a modulation unit configured for modulating the at least one light according to said at least one instruction during the presentation.

### FIELD AND BACKGROUND OF THE INVENTION

The present invention relates to a method and an apparatus for adjusting the presentation of virtual images and, more particularly, but not exclusively, to a method and an apparatus for adjusting the presentation of virtual images in handheld devices.

Individuals and corporations need information to function and do business in information driven society. Increasingly, individuals and corporations are expressing a preference for receiving information in real time through portable electronic devices, which are also known as handheld devices. Examples of portable electronic devices used to receive real time information include cellular telephones, pagers, personal digital assistants, geographical positioning systems, and palm size computers. Generally, these portable electronic devices have a small information display area. For example, a personal digital assistant typically has a flat panel display having an information display area of six or seven square centimeters. A mobile device typically has a liquid crystal display (LCD) for displaying telephone numbers, instructions and other information useful for the user to view during operation of the telephone. The LCD is protected by a display window that has a transparent portion so that the items displayed on the LCD can be easily viewed by the user.

Some unique information display areas are known. For example International Patent Application No. WO 02/080377, published on Oct. 10, 2002, describes hand-held electronic device that enables users to comfortably view large high-resolution content on the device while still being able to easily interact with that content and with the device's other functions. The device includes two displays in the device. One is a micro display for viewing the large high-resolution images when the micro display is held near the eye, and a traditional “direct-view” display like those found on most cell phones today for viewing lower resolution text or images when the phone handset is held at normal or arm's length reading distance. The two displays should be positioned close to one another and in the same line of sight, so that transitioning between near-to-eye viewing of the micro display and arms'-length viewing of the direct-view display is a simple matter of moving the device nearer or further from the eye in a straight line.

Another example is described in U.S. Pat. No. 6,366,267, issued on Apr. 2, 2002 that discloses a portable electronic device with virtual image display including a semiconductor array providing a real image and an optical system mounted to receive the real image and produce a virtual image at a viewing aperture. Electronics are associated with the array to produce real images in accordance with messages received by a data source such as a communication receiver. The display is sufficiently small to mount in a handheld microphone for viewing by the operator while using the microphone.

Another example is described in International Patent Application No. WO 2006/073679, published on Jul. 13, 2006, that describes system, method and apparatus including a first display screen component configured to provide content in a real image display mode and a second display screen component configured to provide content in a virtual image mode, a proximity sensor and an automatic switching module in communication with the proximity sensor for activating the virtual image display screen component and deactivating the real image display screen component in the event the proximity sensor detects an object such as a user within a predetermined distance to the proximity sensor.

### SUMMARY OF THE INVENTION

According to an aspect of some embodiments of the present invention there is provided

According to an aspect of some embodiments of the present invention there is provided a handheld device configured for displaying a modulated image. The handheld device comprises an image generation unit configured for projecting at least one light beam corresponding to image data and allows a presentation of the image data to a user and a user interface configured for receiving at least one instruction for adjusting a display of the image data from the user. The handheld device further comprises a modulation unit configured for modulating the at least one light beam according to the at least one instruction during the presentation.

Optionally, the modulating comprises modulating at least one of the phase and the amplitude of the wavefront of the at least one light beam.

Optionally, the image generation unit is configured for projecting the at least one light beam toward a line of sight of the user.

Optionally, the modulation unit comprises an adaptive optical element in the trajectory of the at least one light beam, the modulation unit being configured for controlling a diffraction factor of the adaptive optical element according to the at least one instruction.

Optionally, the modulation unit comprises a phase modulator in the trajectory of the at least one light beam, the modulation unit being configured for using the phase modulator for performing the modulating.

More optionally, the phase modulator in a member of a group consisting of: a refractive phase modulator and a reflective phase modulator.

Optionally, the image generation unit comprises a laser image projector for emitting the at least one light beam.

Optionally, the modulation unit comprises a deformable mirror in the trajectory of the at least one light beam, the modulation unit being configured for controlling the deformable mirror for performing the modulating.

Optionally, the handheld device is a cellular phone and the user interface is used for operating the cellular phone.

Optionally, the handheld device further comprises a display state manager configured for selecting a first of a plurality of state displays, the modulation unit being configured for modulating the phase of the at least one light beam according to the selected state display.

More optionally, at least one of the plurality of state displays is adjusted according to preferences of the user.

More optionally, the user interface is configured for receiving at least one instruction for adjusting at least one of the state displays.

More optionally, the handheld device further comprises at least one state detector configured for detecting a distance between the user and the modulation unit, the display state manager being configured for selecting the first of the plurality of state displays according to the distance.

More optionally, the handheld device further comprises at least one state detector configured for detecting an illumination around the handheld device, the display state manager being configured for selecting the first of the plurality of state displays according to the illumination.

According to an aspect of some embodiments of the present invention there is provided a method for adjusting a display of a handheld device. The method comprises projecting at least one light beam via a light modulating element, the at least one light beam corresponding to image data of a display, presenting the image to an observer, receiving at least one instruction for adjusting the display from the observer, and modulating the at least one light beam according to the at least one instruction. The modulating is performed during the presenting.

Optionally, the at least one light having a wavefront, the modulating comprises modulating at least one of the phase and the amplitude of the wavefront of the at least one light beam.

Optionally, the modulating comprises manipulating a perceived distance of the image for the observer.

Optionally, the modulating comprises changing the optical power of an optical element in the trajectory of the at least one light beam according to the at least one instruction.

Optionally, the modulating comprises changing a focal point of an optical element in the trajectory of the at least one light beam according to the at least one instruction.

More optionally, the method further comprises detecting a distance to the observer before the modulating and performing the modulating according to the distance.

Optionally, the modulating comprises changing the perceived distance of the image from a point of view of the observer.

Optionally, the projecting comprises projecting a plurality of light beams having at least two separable wavefronts via the light modulating element, each separable wavefront corresponding to one of at least some of the image data, the modulating comprises separately modulating the phase of each wavefront according to respective instruction of the at least one instruction.

More optionally, a first of the at least two separable wavefronts is projected to a first eye of the observer and a second of the at least two separable wavefronts being projected to a second eye of the observer.

According to an aspect of some embodiments of the present invention there is provided a method for adjusting a display of a handheld device. The method comprises projecting at least one light beam toward a first of a plurality of light modulating elements, the at least one light beam corresponding to image data, reflecting the at least one light beam from the first light modulating element to allow a presentation of the image data to an observer, receiving at least one instruction for adjusting the presentation from the observer, and redirecting the projecting toward a second of the plurality of light modulating elements according to the at least one instruction. The redirecting is performed during the presentation.

Optionally, the light modulating element is configured for modulating the at least one light beam according to a respective of a plurality of modulation states.

More optionally, each modulation state is selected from a group consisting of: a perceived distance, a focal power, a focal length, a magnification and an optical aberration correction.

More optionally, each modulation state is configured for adjusting at least one of the phase and the amplitude of the wavefront of the at least one light beam in a different manner.

According to an aspect of some embodiments of the present invention there is provided a handheld device having a configurable display. The handheld device comprises a reflective unit having a plurality of light modulating elements, an image generation unit configured for projecting at least one light beam, corresponding to image data, toward a first of the plurality of light modulating elements to allow a presentation of the image data to a user, and a user interface configured for receiving at least one instruction for adjusting the presentation from the user. The image generation unit is configured for redirecting the projecting toward a second of the plurality of light modulating elements according to the at least one instruction, the redirecting being performed during the presentation.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user interface such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a handheld device 100, according to some embodiments of the present invention;

FIG. 2 is a flowchart of a method for adjusting an image presented by a handheld device, according to some embodiments of the present invention;

FIG. 3 is a schematic lateral illustration of an exemplary handheld device that uses a refractive phase modulator for projecting an image toward a line of sight of a user, according to some embodiments of the present invention;

FIG. 4 is a schematic illustration of a known refractive phase modulator, according to some embodiments of the present invention;

FIG. 5 is a schematic lateral illustration of an exemplary handheld device that projects an image, via a reflective phase modulator, toward the line of sight of a user, according to some embodiments of the present invention;

FIG. 6 is a schematic illustration of a handheld device with a deformable mirror for modulating the phase of the wavefront light beams, according to some embodiments of the present invention;

FIG. 7A is a schematic illustration of a handheld device with a modulation unit that includes a passive reflective element, according to some embodiments of the present invention;

FIG. 7B is a schematic illustration of a handheld device with a modulation unit that includes a beam source, such as a retinal scanning laser, according to some embodiments of the present invention; and

FIG. 8 is a flowchart of a method for adjusting a display and/or a projection of a handheld device, according to some embodiments of the present invention.

### DESCRIPTION OF SPECIFIC EMBODIMENTS OF THE INVENTION

The present invention relates to a method and an apparatus for adjusting the presentation of virtual images and, more particularly, but not exclusively, to a method and an apparatus for adjusting the presentation of virtual images in handheld devices.

According to some embodiments of the present invention there is provided a handheld device, such as a cellular phone, which may adjust the presentation of image data, such as image data of a GUI thereof, by modulating the phase of the wavefront of light beams corresponding to the image data. The handheld device comprises an image generation unit, such as a laser image projector or a micro-display, which is configured for projecting light beams having a wavefront. The light beams corresponding to image data and allows a presentation of a virtual image to a user. The handheld device further comprises a user interface, such as a keypad, for receiving instructions for adjusting the presentation of the virtual image from the user. The handheld device further comprises a modulation unit for modulating the phase of the wavefront according to the instructions during the presentation of the virtual image. In such a manner, the user may adjust presentation without interrupting and/or delaying the presentation of the virtual image and/or while still being able to easily interact with any function of the handheld device. The handheld device may comprise a mode detection unit for automatically detecting a status and/or an activity of the user and adjusting the presentation of the virtual image accordingly. Optionally, the mode detection unit is connected to an image sensor and configured for detecting whether the user wears glasses or contact lenses or not. In such an embodiment, the presentation may be automatically adjusted without interrupting and/or delaying the presentation of the virtual image, for example as described above.

Optionally, the modulation unit may use an optical element, such as a phase modulator, such as refractive and/or reflective phase modulator, for modulating the phase of the wavefront of the light beams. Optionally, the modulation unit may use an optical element, such as a deformable mirror for modulating the phase of the wavefront of the light beams.

Optionally, the handheld device may include a display state manager that is designed to instruct the modulation unit and/or the image generation module according to manual and/or automatic selections of various state displays, such as different perceived distances, focal powers, focal lengths, magnifications and optical aberration corrections. In such an embodiment, the user may use the user interface of the handheld device for selecting a state display that is suitable to his current sighting abilities and/or current illumination.

According to some embodiments of the present invention there is provided a handheld device having a configurable display which is based on a configurable image generation unit that may be configured to project light beams toward a plurality of different light modulating elements. Optionally, the handheld device comprises a reflective unit having a plurality of light modulating elements and a configurable image generation unit for separately projecting light beams corresponding to image data toward any of a plurality of light modulating elements to allow a presentation of said image data to a user. In such an embodiment the image generation unit may receive instruction which are intercepted by the user interface of the handheld and adjust the presentation by redirecting the projecting toward a light modulating element which is associated with the received instructions. Such a redirecting may be performed during the presentation, without interrupting and/or delaying it and/or while still allowing the user to easily interact with any function of the handheld device.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

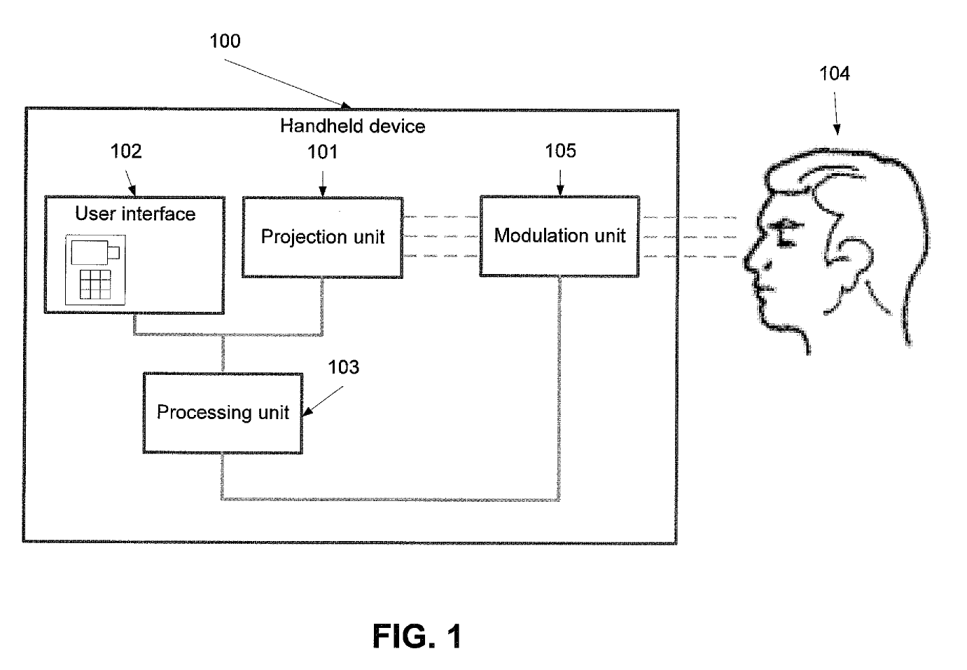

Reference is now made to FIG. 1, which is a schematic illustration of a handheld device 100, according to some embodiments of the present invention. As used herein a handheld device means, a mobile communication terminal, such as a cellular phone, a portable computing unit, such as a personal digital assistant (PDA), a portable projector, a Smartphone, and an internet tablet. The mobile communication terminal may be a cellular or cordless telephone, a two-way radio, a pager, and a portable data bank device.

The handheld device 100 comprises an image generation unit 101, optionally integrated, which is configured for projecting one or more light beams corresponding to image data, for example as further described below. As used herein image data means any data of a visual media content, such as an color image, a gray color image, a graphical user interface, a user interface, a two dimensional (2D) image, a three dimensional (3D) image, and a video. The image generation unit 101 is designed for forming a virtual image at the position where the paths of the one or more light beams cross. As used herein an image generation unit means an optical system for projection, a laser diffuser, a virtual retinal display laser, a laser image projector, a micro-display, and/or any apparatus which may be used for projecting a virtual image. Additionally or alternatively, the image generation unit 101 may form two virtual images, each for each eye of the observer. In such a manner, the handheld device 100 may allow the user to view comfortably the image data from a relatively short distance, for example from ten centimeters or less.

The handheld device 100 further comprises a user interface 102 which is designed for receiving one or more instructions from the user of the handheld device 100. The user interface 102 may be a keypad, a keyboard, a writing pad, a pointing device, such as a mouse, a roller, a set of buttons, and/or any type of keyboard or writing pad which is integrated into the handheld device 100. Additionally or alternatively the user interface 102 may include a microphone for intercepting voice commands.

The image generation unit 101 and the user interface 102 may be connected to a central processing unit (CPU) and/or a digital signal processing (DSP) which may be referred to herein as a processing unit 103. Optionally, the processing unit 103 runs a real-time operating system (RTOS) that is responsible for coordinating all functions of the handheld device 100. The processing unit 201 is optionally used for analyzing the outputs of the user interface 102 which are described below.

The user interface 102 may be used for allowing the user 104 to input instructions for adjusting the presentation of the virtual image. The instructions, which are optionally processed using the processing unit 103, are used for controlling a modulation unit 105 which is positioned in the trajectory of the one or more light beams. The modulation unit 105 modulates the wavefront of the one or more light beams according to the instructions of the user 104, for example the phase and/or the amplitude thereof.

In some embodiments of the present invention, the modulation unit 105 is an adaptive optical element having one or more adaptive optical parameters which are adjusted, during the presentation of the virtual image, according to the instructions of the user 104. As further exemplified below, the adaptive optical element may be reflective, refractive and/or diffractive.

Optionally, by changing one or more of the adaptive optical parameters, the modulation unit 105 adjusts the distance between the image generation unit 101 and a projection plane on which the virtual image is projected.

Optionally, by changing one or more of the adaptive optical parameters, the modulation unit 105 adjusts the controlling the phase of the wavefront of the projected light beams.

Optionally, by changing one or more of the adaptive optical parameters, the modulation unit 105 adjusts the viewing angle of the virtual image by changing the relative angle of the projection plane in relation to the image generation unit 101. Such an adjustment may be made by tilting the wavefront to present an image in which a different viewing angle is presented.

Optionally, by changing one or more of the adaptive optical parameters, the modulation unit 105 adjusts the perceived distance of the virtual image that is projected by the image generation unit 101. In such a manner, the modulation unit 105 may modify the perceived distance to alleviate the effects of nearsightedness, also referred to as myopia, and/or farsightedness, also referred to as hyperopia, for example as described in U.S. Provisional Patent Application No. 12/007,879, filed on Jan. 16, 2008, which the content thereof is hereby incorporated by reference.

Optionally, by changing one or more of the adaptive optical parameters, the modulation unit 105 adjusts the focal point and/or the optical power of the adaptive optical element. In such a manner, the modulation unit 105 may adjust the virtual image instead of corrective lens or spectacles.

As described above, the image generation unit 101 may project two separate images, each for a different eye. In such an embodiment, each one of the images may be modulated separately, for example in a manner that modifies the focal length of the eye to alleviate the effects of nearsightedness, farsightedness and/or astigmatism.

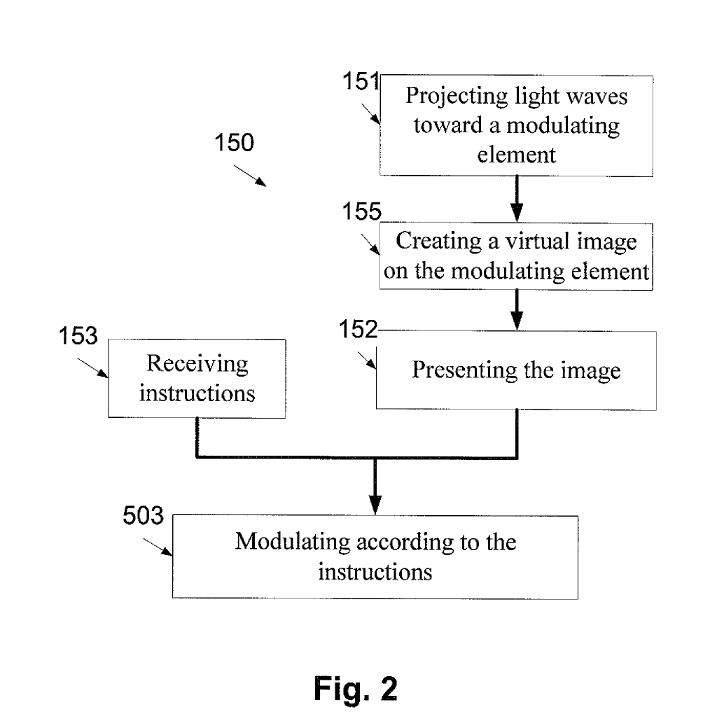

Reference is now also made to FIG. 2, which is a flowchart 150 of a method for adjusting a display of a handheld device, according to some embodiments of the present invention. First, as shown at 151, light beams 304 are projected, for example by the image generation unit 101, towards a light modulating element, as shown at 105. The light beams 304 create a virtual image on the light modulating element 105, as shown at 155. The light modulating element 105, which may modulate the light waves of image, for example as described below, allows the passage and/or directs the light beams to in a manner that facilitate the presentation of image data, such as of a GUI, to the user 104, as shown at 152. During the presentation of the image data, as shown at 153, one or more instructions for adjusting the presentation are received from the user. Now, as shown at 154, the phase of the wavefront is modulated according to the at least one instruction, during the presentation of the image data. In such a manner, the user 104 may adjust optical characteristics of an optical element of the modulation unit 105 to improve the viewing experience without interrupting and/or delaying the presentation of the image data, for example as described below.

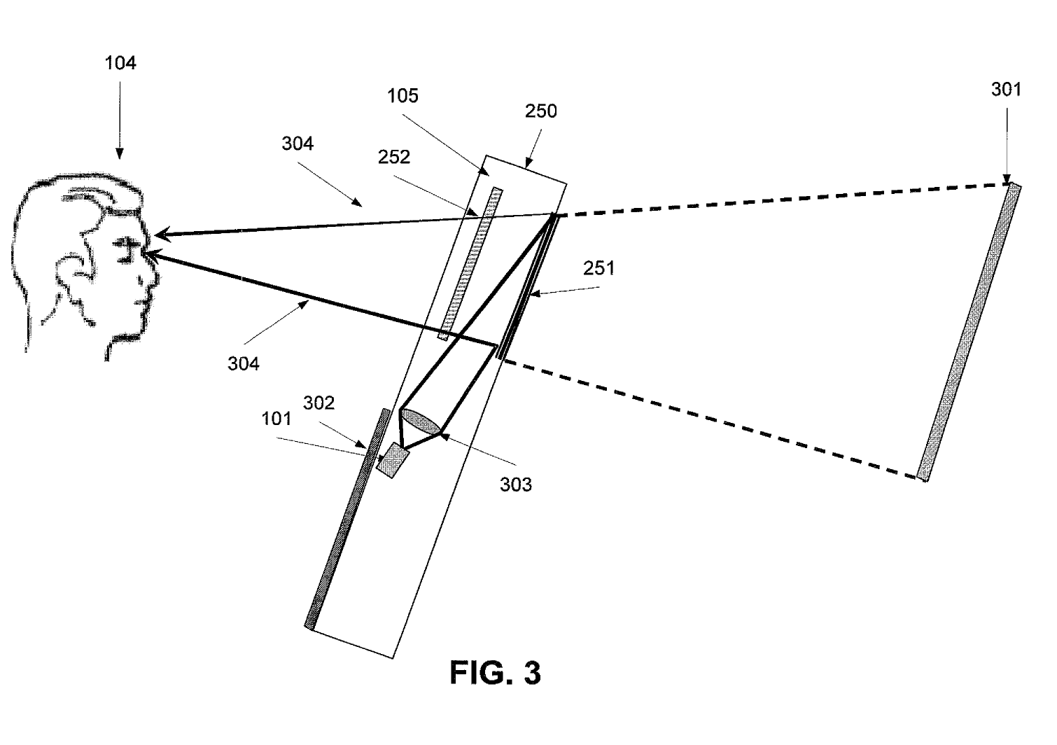

Reference is now made to FIG. 3, which is a schematic lateral illustration of an exemplary handheld device 250 that uses a refractive phase modulator 252 for projecting an image, such as a display of a cell phone, toward the line of sight of a user, as shown at 104, according to some embodiments of the present invention. The user 104, the image generation unit 101, and the modulation unit 105 are the same as described above. FIG. 3 further depicts the arrangement of these components in an exemplary handheld device 100, such as a cellular phone. The figure further depicts an exemplary optical path of the light beams 304 which are projected by the image generation unit 101 toward a reflective element 251, such as a mirror. The reflective element 251 further reflects the light beams toward the modulation unit 105, which optionally uses a refractive phase modulator 252. The refractive phase modulator 252 modulates the light beams according to the received instructions and refracts some or all of the modulated beams toward the user 104, in a trajectory that extends the optical path toward a projection plane that are perpendicular, or approximately perpendicular, to the light of sight of the user 104. The optical path is extended between the refractive phase modulator 252 and the user 104. Optionally, the exemplary handheld device 100 comprises a screen 111. In such an embodiment, the projection plane may be parallel to the screen and the light beams, which are emitted from the modulation unit 105, may transmit an image via the screen 111. FIG. 3 further depicts a virtual image 301 of the source, like a magnifying glass, that is formed on the reflective element 251. Optionally, the user interface 102 is a keypad, for example as shown at 302, and/or any other user interface of the exemplary cellular phone of FIG. 3.

In such an embodiment, the modulation unit 105 may modulate the light beams 304 in a manner that changes the perceived distance of the virtual image from the user 104, the focal point and/or optical power of the light beams 304, and/or any other optical parameters that affects the phase of the wavefront of the light beams 304 which are reflected from the reflective element 251.

The adjustment of the modulation that is performed by the modulation unit 105 is performed in real time. In such a manner, the user may use the user interface 102 for adjusting the presentation of the virtual image 301 while she uses it. For example, the user may adjust one or more optical characteristics of the modulation unit 105 to tune the presentation of the virtual image 301 while using the handheld device 100. Optionally, the adjustment may be perform without having to stop one or more of the applications which are executed on the handheld device 100 and interrupting the presentation of the projected image data. For example, the projected image data may include a graphical user interface (GUI) of the handheld device 100, media content, such as an image, a video file, and/or text. The ability to adjust the modulation which is performed by the modulation unit 105 in real time allows continuous presentation of the projected image data during the adjustment of the optical characteristics. In such a manner, the user experience of the user 104 improves and the adjustment procedure becomes easier. In this context, the term “real time” means that the time the modulation unit 105 takes to change and/or adjust to a new phase modulating configuration is sufficiently short not to introduce any significant delay in its presentation to the user 104. In use, the user 104 may use the keypad 302, or any other UI of the cellular phone 300, for changing, in real time, one or more optical characteristics of the virtual image 301. It should be noted that though the virtual image 301 is depicted in a perceived distance that is longer than the actual distance between the reflective phase modulator 104 and the user 104, the perceived distance of the virtual image 301 may be shorter than and/or equal to the actual distance.

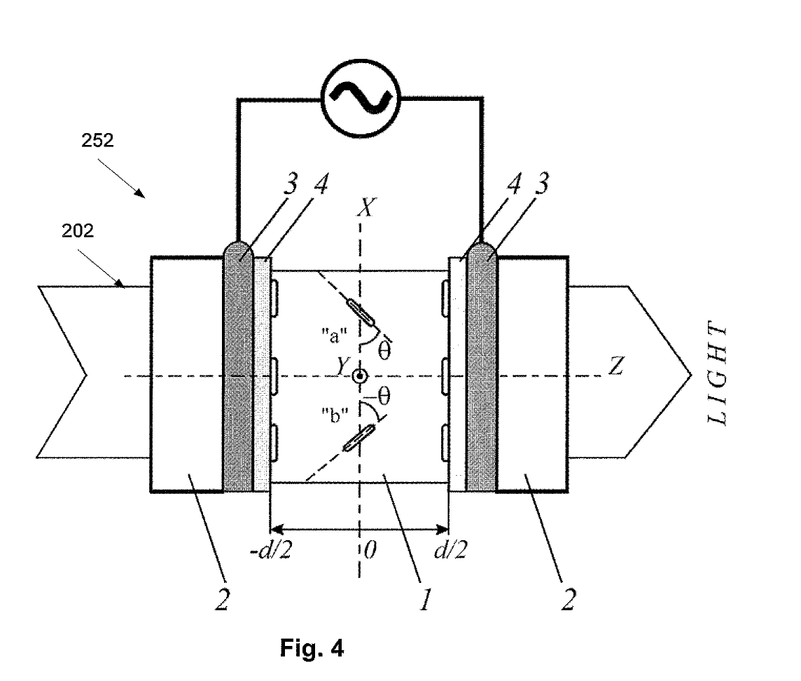

Reference is now also made to FIG. 4, which is a schematic illustration of a refractive phase modulator 251, such as the refractive phase modulator 251 that is depicted in FIG. 3, according to some embodiments of the present invention. In such an embodiment, the refractive phase modulator 251 may be used for modulating the light beams 202 which are later reflected toward a projection plane, optionally via the line of sight of the user.

Optionally, the refractive phase modulator 252 modulates more light beams 202, which are emitted from the image generation unit 101, according to the user instructions. The refractive phase modulator 252 includes an optical element, such as a liquid crystal (LC) layer 1 that is positioned between two transparent layers 2, such as glass substrates, two electrodes 3, optionally substantially transparent, and two alignment layers 3. The molecules of the LC layer 1 are arranged in angle θ in relation to a plane which is perpendicular to the light beams 202. This arrangement determines the modulation of the light beams which are transmitted via the LC layer 1.

Optionally, the nematic LCs of the LC layer 1 are designed to polarize the one or more light beams. In such an embodiment, the LC layer 1 may be a linear waveplate, such as a half-wave plate that is used for rotating the polarization state of a plane polarized light.

Optionally, the LC layer 1 is designed for splitting the light beam 202 into two parallel polarized perpendicularly rays. This splitting may be understood as birefringence. The splitting may be controlled by applying an altering current that adjusts the one or more optical parameters of the LC layer 1. Optionally, the voltage which is applied by the electrodes 3 varies between approximately 0V and approximately 10V of alternating current (AC) and the birefringence value of the light beams 202 is respectively changed between approximately 0.2 and approximately 0.

For clarity, the change in the optical path of the light beam 202 which is brought about by the voltage may be described as:

C=Δn·d

where C denotes a change in the optical path, Δn denotes the birefringence value and d denotes the thickness of the LC layer 1, which is optionally 10 micrometer (μm). The modulation unit 105 may be configured according to other similar modalities, for example as described in the article Modally Addressed Liquid Crystals of University of Durham Astronomical Instrumentation Group which is published in http://www.cfai.dur.ac.uk/fix/projects/lcs/ma.html and incorporated herein by reference.

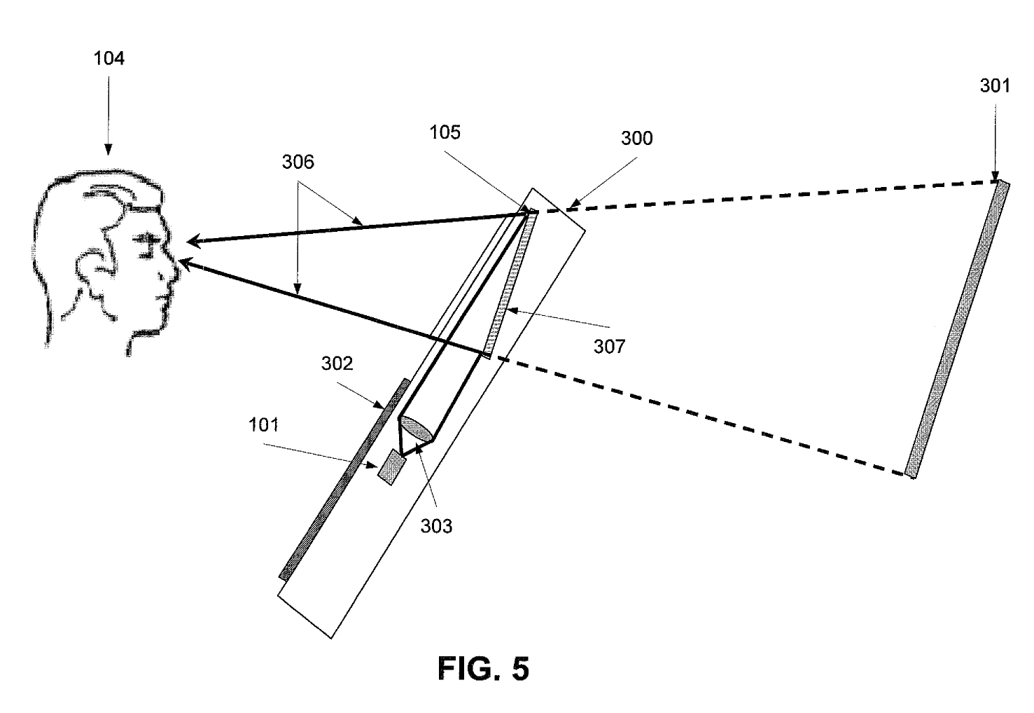

Reference is now made to FIG. 5, which is a schematic lateral illustration of an exemplary handheld device 300 that projects an image toward the line of sight of a user, such as user 104, according to some embodiments of the present invention. The user 104, the virtual image 301, the keypad 302, the image generation unit 101, and the modulation unit 105 are the similar to the described in FIG. 3 above. However, FIG. 5 depicts a different arrangement of these components in an exemplary handheld device 300, such as a cellular phone. In FIG. 5, the modulation unit 105 comprises a reflective phase modulator 307. The optical path of light beams 306 which are reflected from the image generation unit 101 is extended between the image generation unit 101 and the reflective phase modulator 307. The optical path 306 further extended in the light of sight of the user 104, as the modulated light beams 306 are reflected toward a projection plane that is perpendicular, or substantially perpendicular to the line of sight of the user.

Optionally, the reflective phase modulator 307 is a spatial light modulator (SLM), for example as described in Sang Kyeong Yun et al, Spatial optical modulator (SOM): Samsung's light modulator for next-generation laser displays, Electronic Components and Technology Conference, 2008, ECTC 2008 58th Volume, Issue 27-30, May 2008 Page(s):773-778, which is incorporated herein by reference.

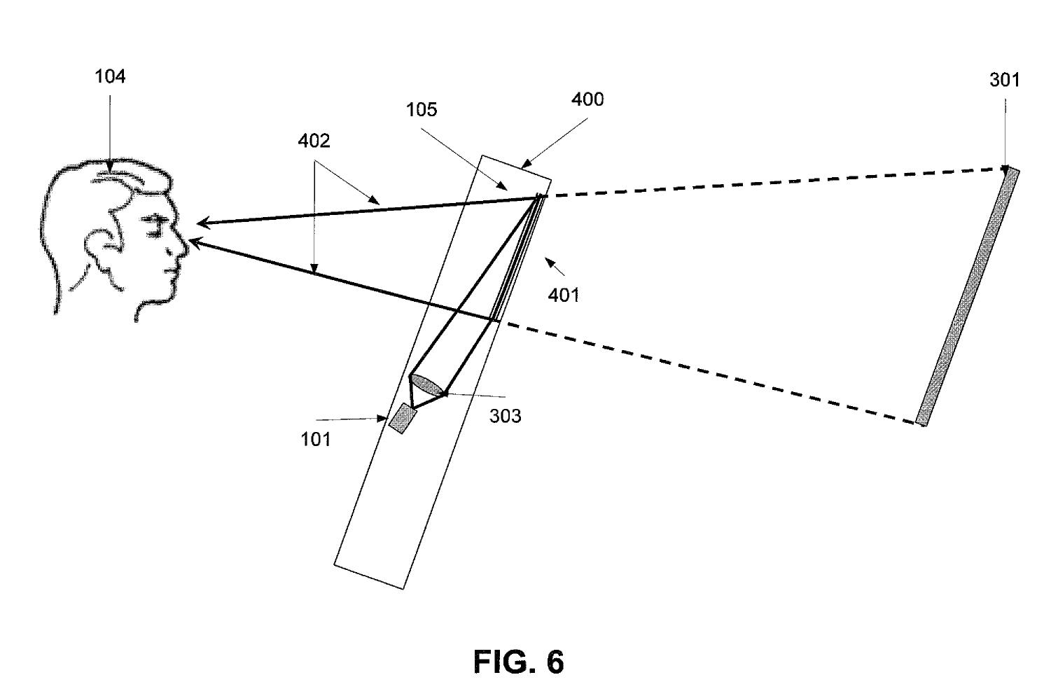

Reference is now also made to FIG. 6, which is a schematic illustration of a handheld device 400 with a deformable mirror 401 deformable mirror for modulating the phase of the wavefront light beams, according to some embodiments of the present invention. The user 104, the keypad 302, the virtual image 301, the image generation unit 101, and the modulation unit 105 are the similar to the described in FIG. 3 above. However, FIG. 6 depicts a different arrangement of these components in an exemplary handheld device 400, such as a cellular phone. In FIG. 6, the modulation unit 105 comprises a deformable mirror 401.

Optionally, the modulation unit 105 uses a deformable mirror, for example as shown at 401, for reflecting one or more light beams 402, which are emitted from the image generation unit 101, toward the deformable mirror 401 that directs them toward the projection plane. The reflections of the one or more light beams 402 are modulated by the surface of the deformable mirror 401 according to the user instructions.

Optionally, the deformable mirror 401 has a plurality of degrees of freedom, each associated with one or more mechanical actuators. Optionally, the one or more mechanical actuators are designed to control, locally and/or spatially, the phase of the wavefront of the one or more light beams 402 which are reflected from reflected from the deformable mirror 401.

Optionally, the one or more mechanical actuators and the deformable mirror 401 comprise a microelectromechanical system, for example as described in Mali et al., Development of microelectromechanical deformable mirrors for phase modulation of light, Optical Engineering, vol. 36, No. 2, pp. 542-548, February 1997 which is incorporated herein by reference. In such an embodiment, the deformable mirror 401 is a silicon-based, surface micromachined, deformable mirror device which is designed for performing phase modulation by adaptive optics. The deformable mirror 401 is adjusted according to the instructions which are received from the user, for example as described above.

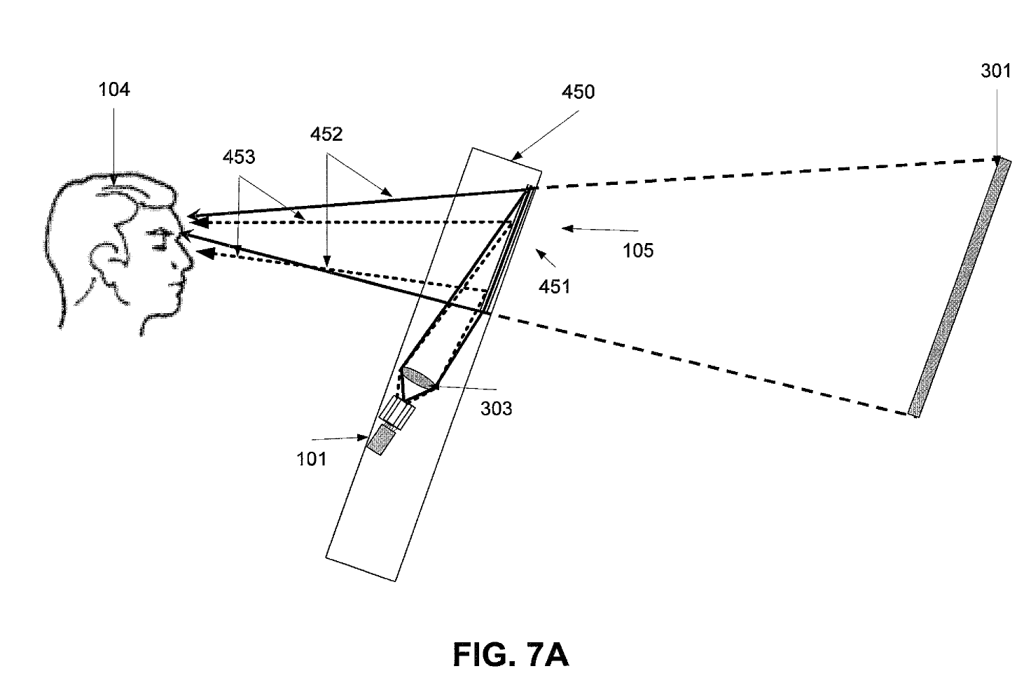

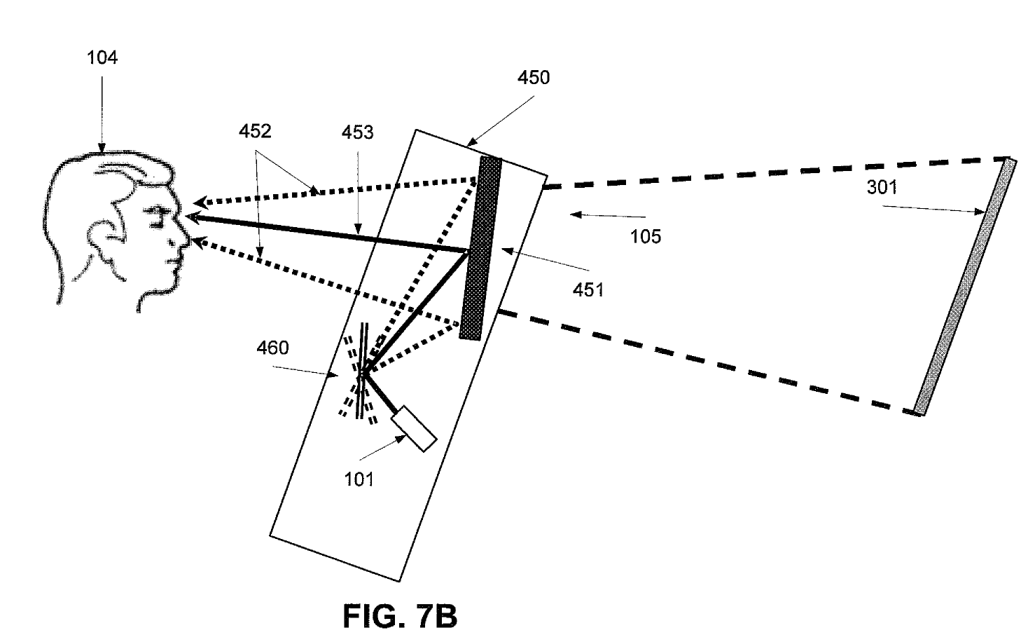

Reference is now also made to FIG. 7A, which is a schematic illustration of a handheld device 450 with a modulation unit 101 that includes a reflective element 451, optionally passive, according to some embodiments of the present invention. The user 104, the keypad 302, and the virtual image 301 are the similar to the described in FIG. 3 above. However, FIG. 7A depicts a different arrangement of these components in an exemplary handheld device 450, such as a cellular phone. In FIG. 7A, the image generation unit 105, such as a laser diffuser and/or a laser image projector is designed to control the angle of the light beams which are projected toward the passive reflective element 451. Optionally, the passive reflective element 451 is an optical element, such as a mirror, having a plurality of light modulating elements. Each light modulating element is adjusted according to one or more of optical parameters. For example, each light modulating element may modulate the phase of the wavefront of the one or more light beams in a different manner, for example in a manner that corrects a different set of one or more optical aberrations and/or modifies the perceived distance of the virtual image 301, the focal length between the user 104 and the projection unit 105, the magnification of the image projected by the projection unit 105, and/or any combination thereof.

Reference is now also made to FIG. 7B, which is another schematic illustration of the handheld device 450, which is depicted in FIG. 7A, with a modulation unit 101 that includes a light source, such as a retinal scanning laser, a reflective element 451, such as a deformable mirror or a micro mirror array and a scanning mirror 460, such as a micro electromechanical system (MEMS) scanning mirror 460, according to some embodiments of the present invention. Optionally, the light source includes a projector, such as a retinal scanning laser, a digital light processing (DLP) projector and/or any laser source that is design emit a laser beam toward the MEMS scanning mirror 460. The MEMS scanning mirror 460 generates a scanning pattern on the reflective element 451. Optionally, the reflective element 451 comprises a plurality of pixels; each redirects the beam or a portion thereof in a different angle. In such an embodiment, the reflective element 451 may be an array with mirrors having a deformed shape, such as a spherical or aspherical mirror, that diffuses the received beam. The reflective element 451 comprises a micro-mirror and/or a deformable mirror that has interlaced areas which correspond to different projection instruction. The beam scans the area corresponding with the projection instruction.

Optionally, each light modulating element comprises a plurality of sub elements. The sub elements of one light modulating element may be interlaced among sub elements of other light modulating elements. In such an embodiment, the sub elements of one light modulating element may be scattered on the surface of the passive reflective element 451, among sub elements of other light modulating elements. Optionally, the sub elements of one light modulating element may be designed to reflect the phase of the wavefront of the impinging light beams in one manner and the sub elements of another light modulating element may be designed to reflect the phase of the wavefront of similar impinging light beams in another manner. In such a manner, each light modulating element may modulate the phase of the wavefront of the light beams which are directed thereto in a different manner. In use, instructions received from the user interface 102 are used for directing the image generation unit 101 to project the light beams toward a selected light modulating element. The selected light modulating element is designed to modulate the phase of the wavefront of the light beams according to the received instructions. For example, each one of the light modulating elements may be adjusted to reflect the phase of the wavefront of a received light beam with a different focal point and/or optical power.

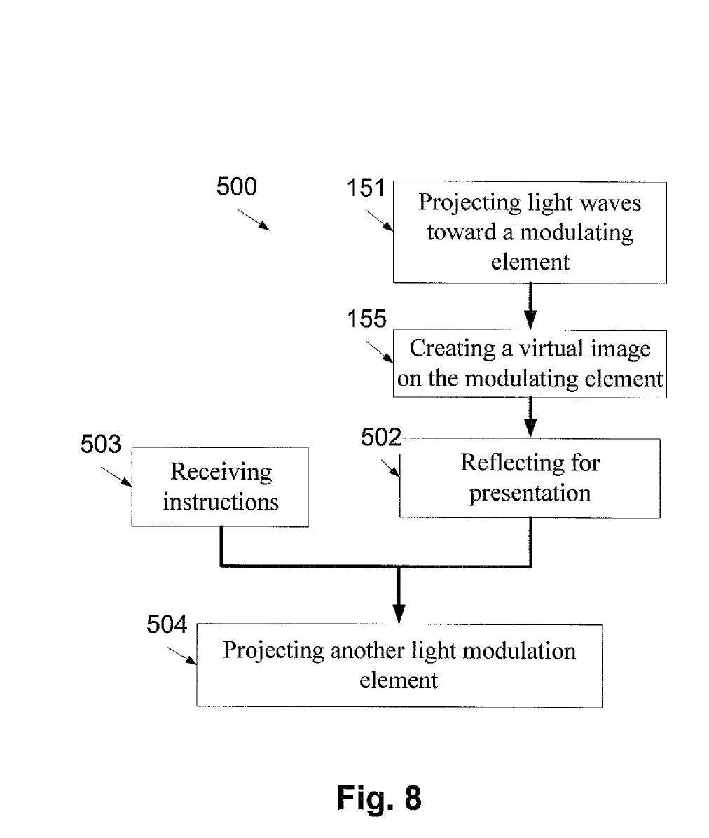

Reference is now also made to FIG. 8, which is a flowchart of a method 500 for adjusting an image and/or a projection of a handheld device, according to some embodiments of the present invention. First, as shown at 151 and 152 and described above, light beams are projected toward one of the light modulating elements of the passive reflective element 451 and create a virtual image thereupon. The light beams correspond to image data, for example as described above. As shown at 502, the light beams are reflected from the light modulating element to allow the presentation of the image data to the user 104, for example as shown at numeral 452 of FIG. 7A. In parallel, as shown at 503, one or more instructions, which are used for adjusting the presentation, are received from the user 104. Now, as shown at 504 the projection of the light beams is redirected toward another of the plurality of light modulating elements of the passive reflective element 451 according to the received instruction. The redirecting is performed in real time, during the presentation of the image data.

In some embodiments of the present invention, the user interface 102 may allow the user 104 to select and/or enter a preferred focal point and/or optical power and/or to her glasses prescription and the image generation unit 101 may project the high beams toward the light modulating element that is suitable for the user's selection and/or data entry. In such a manner, the virtual image that is projected on the projection plane may be modulated to meet the optical requirement of the user 104.

Reference is now made, once again, to FIG. 1. As described above, the handheld device 100 allows the user 104 to control the presentation of the image data by changing various optical characteristics of an optical element of the modulation unit 105 in real time. In some embodiments of the present invention, the handheld device 100 comprises a repository that is designed for storing a list of modulation arrangements. Each modulation arrangement defines a different display state for the modulation unit 105, which may be an adaptive optical element. For example, each modulation arrangement may define values of one or more of the optical parameters of the optical element. Optionally, different display states may define optical preferences of different users, environmental parameters, such as light intensity, trembling level of the handheld device 100, general motion of the handheld device 100 and the like, and any combination thereof. Additionally, or alternatively, different display states may define different viewing modes, such as night and day viewing modes or individual or shared viewing mode. Optionally, different display states may be adjusted to different corrective lenses, such as corrective lenses of glasses and/or to the absence of corrective lenses. For example, one display state may be adjusted for viewing with corrective lenses, such as glasses, and the other is used for viewing without. Optionally, each one of the exemplary display states defines the focal point and/or the optical power of the adaptive optical element in a manner that corrects the presentation to fit the respective viewing mode of the user. Optionally, each state display is associated with a light modulating element and/or a modulation of the modulation unit. In such an embodiment, a display state which is selected automatically or manually, for example as further described below, may instruct the image generation unit and/or the modulation unit to adjust according to the respective associated light modulating element and/or modulation.

In use, the user 104 optionally uses the user interface 102 for selecting one of the display states and the modulation unit 105 adjusts the adaptive optical element accordingly, optionally as described below. For example, the user may use the keypad of the handheld device 100 to select a mode from a list that is presented on the display thereof. Optionally, the handheld device 100 displays a GUI that allows the user to select and/or to adjust a preferred display state. Optionally, the handheld device 100 comprises a display state manager that is designed to instruct the modulation unit 105 and/or the image generation module according to a manual and/or automatic selection of a state display. Optionally, the display state manager is designed to automatically select a display state according to the time of the day and/or date. In such a manner, a display state that is adjusted for strong illumination may be selected in the day, a display state that is adjusted mild illumination may be provided at dawn and at sunset, and a display state that is adjusted to low illumination may be provided during the night time. For example, the following table describes different display states which are adjusted, defined in foot-lambert (ft-L) units, for different illuminations, defined in foot-candle (ft-cd), by allowing the illumination of the display by different level of luminance:

| Condition | Illumination (ft-cd) | Display illumination (Ft-L) |
|---|---|---|
| Full Daylight | 1,000 | 3000 |
| Overcast Day | 100 | 1000 |
| Very Dark Day | 10 | 500 |
| Twilight | 1 | 200 |
| Deep Twilight | .1 | 100 |
| Full Moon | .01 | 100 |
| Quarter Moon | .001 | 100 |
| Starlight | .0001 | 100 |
| Overcast Night | .00001 | 100 |

In some embodiments of the present invention, the display state manager is connected to one or more state detectors. Optionally, the display state manager may be connected to one or more light sensors that function as state detectors. The light sensors detect the intensity of the illumination around the handheld device 100 and change the instructions to the modulation unit 105 accordingly.

Optionally, the display state manager may be connected to a state detector, such as a range detector, such as an ultrasonic range detector, which is designed to detect the distance between the user 104 and the image generation unit 101. In such an embodiment, the modulation unit 105 automatically selects a display state that is adjusted to the detected distance and/or automatically instructs the modulation unit 105 to adjust the optical element according to this distance.

Optionally, the display state manager may be connected to an image sensor, such as the camera of the handheld device 100 that functions as a state detector. The image sensor may be used for detecting the distance between the user 104 and the image generation unit 101 and/or modulation unit 105, for example by using image processing algorithms for analyzing a current image of the user 105 and determining the distance on the basis of the relative size of the face and/or eyes thereof. Such image processing algorithms are known and therefore not discussed with greater specificity herein. Optionally, the image sensor may be used for detecting the face of the user 104, for example using face recognition methods. The detection of the face may be used for evaluating the distance to the user, for example for automatic zoom of the virtual image. Optionally, the image sensor may be used for detecting whether the user wears eye glasses and/or lens or not. In such an embodiment, the state mode of the modulation unit may be adjusted according to the output of the image sensor.

Optionally, the display state manager may be connected to a positioning unit, such as a system global positioning system (GPS), which is designed to detect the geographical location of the handheld device 100 and to select a display state accordingly. In such an embodiment, different areas, such as rural and urban, may be used for selecting a display state. Optionally, the satellite signal reception status, which is effected by the weather, is used for selecting a display state. For example, as a cloudy weather affects the satellite signal reception, identifying this effect may be used for selecting a display state that is adjusted for cloudy illumination conditions.

Optionally, the user 105 uses the user interface 102 for adjusting and/or creating display states, for example during a calibration session. In such an embodiment, the user may define various display states, for example such as night viewing state, day viewing state, corrective lenses state, no corrective lenses state, from a first, second, an/or third distance between her and the handheld device 100, and/or any combination of these states. As described above, the display state may be separately adjusted for each one of the eyes.

It is expected that during the life of a patent maturing from this application many relevant systems and methods will be developed and the scope of the term user interface, image generation module, and modulation unit is intended to include all such new technologies a priori.

As used herein the term “about” refers to ±10%

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A handheld device configured for displaying a modulated image, comprising:
an image generation unit configured for projecting at least one light beam corresponding to image data and allows a presentation of said image data to a user;
a user interface configured for receiving at least one instruction for adjusting a display of said image data from said user; and
a modulation unit configured for modulating said at least one light beam according to said at least one instruction during said presentation.

2. The handheld device of claim 1, wherein said modulating comprises modulating at least one of the phase and the amplitude of the wavefront of said at least one light beam.

3. The handheld device of claim 1, wherein said image generation unit is configured for projecting said at least one light beam toward a line of sight of said user.

4. The handheld device of claim 1, wherein said modulation unit comprises an adaptive optical element in the trajectory of said at least one light beam, said modulation unit being configured for controlling a diffraction factor of said adaptive optical element according to said at least one instruction.

5. The handheld device of claim 1, wherein said modulation unit comprises a phase modulator in the trajectory of said at least one light beam, said modulation unit being configured for using said phase modulator for performing said modulating.

6. The handheld device of claim 5, wherein said phase modulator in a member of a group consisting of: a refractive phase modulator and a reflective phase modulator.

7. The handheld device of claim 1, wherein said image generation unit comprises a laser image projector for emitting said at least one light beam.

8. The handheld device of claim 1, wherein said modulation unit comprises a deformable mirror in the trajectory of said at least one light beam, said modulation unit being configured for controlling said deformable mirror for performing said modulating.

9. The handheld device of claim 1, wherein the handheld device is a cellular phone and said user interface is used for operating said cellular phone.

10. The handheld device of claim 1, further comprising a display state manager configured for selecting a first of a plurality of state displays, said modulation unit being configured for modulating the phase of said at least one light beam according to said selected state display.

11. The handheld device of claim 10, wherein at least one of said plurality of state displays is adjusted according to preferences of said user.

12. The handheld device of claim 10, wherein said user interface is configured for receiving at least one instruction for adjusting at least one of said state displays.

13. The handheld device of claim 10, further comprising at least one state detector configured for detecting a distance between said user and said modulation unit, said display state manager being configured for selecting said first of said plurality of state displays according to said distance.

14. The handheld device of claim 10, further comprising at least one state detector configured for detecting an illumination around the handheld device, said display state manager being configured for selecting said first of said plurality of state displays according to said illumination.

15. A method for adjusting a display of a handheld device, comprising:
projecting at least one light beam via a light modulating element, said at least one light beam corresponding to image data of a display;
presenting said image to an observer;
receiving at least one instruction for adjusting said display from said observer; and
modulating said at least one light beam according to said at least one instruction;
wherein said modulating is performed during said presenting.

16. The method of claim 15, wherein said at least one light having a wavefront, said modulating comprises modulating at least one of the phase and the amplitude of the wavefront of said at least one light beam.

17. The method of claim 15, wherein said modulating comprises manipulating a perceived distance of said image for said observer.

18. The method of claim 15, wherein said modulating comprises changing the optical power of an optical element in the trajectory of said at least one light beam according to said at least one instruction.

19. The method of claim 15, wherein said modulating comprises changing a focal point of an optical element in the trajectory of said at least one light beam according to said at least one instruction.

20. The method of claim 15, further comprising detecting a distance to said observer before said modulating and performing said modulating according to said distance.

21. The method of claim 15, wherein said modulating comprises changing the perceived distance of said image from a point of view of said observer.

22. The method of claim 15, wherein said projecting comprises projecting a plurality of light beams having at least two separable wavefronts via said light modulating element, each said separable wavefront corresponding to one of at least some of said image data, said modulating comprising separately modulating the phase of each said wavefront according to respective instruction of said at least one instruction.

23. The method of claim 22, wherein a first of said at least two separable wavefronts is projected to a first eye of said observer and a second of said at least two separable wavefronts being projected to a second eye of said observer.

24. A method for adjusting a display of a handheld device, comprising:
projecting at least one light beam toward a first of a plurality of light modulating elements, said at least one light beam corresponding to image data;
reflecting said at least one light beam from said first light modulating element to allow a presentation of said image data to an observer;
receiving at least one instruction for adjusting said presentation from said observer; and
redirecting said projecting toward a second of said plurality of light modulating elements according to said at least one instruction;
wherein said redirecting is performed during said presentation.

25. The method of claim 24, wherein said light modulating element is configured for modulating said at least one light beam according to a respective of a plurality of modulation states.

26. The method of claim 25, wherein each said modulation state is selected from a group consisting of: a perceived distance, a focal power, a focal length, a magnification and an optical aberration correction.

27. The method of claim 25, wherein each said modulation state is configured for adjusting at least one of the phase and the amplitude of the wavefront of said at least one light beam in a different manner.

28. A handheld device having a configurable display, comprising:
a reflective unit having a plurality of light modulating elements;
an image generation unit configured for projecting at least one light beam, corresponding to image data, toward a first of said plurality of light modulating elements to allow a presentation of said image data to a user; and
a user interface configured for receiving at least one instruction for adjusting said presentation from said user;
wherein said image generation unit is configured for redirecting said projecting toward a second of said plurality of light modulating elements according to said at least one instruction, said redirecting being performed during said presentation.
